(19) United States
(12) Patent Application Publication
(10) Pub. No.: US 2019/0082671 A1
(43) Pub. Date: Mar. 21, 2019

(54) EQUINE PODIATRY APPARATUS AND METHOD OF TREATMENT

(71) Applicants: Christine G. Schilling, Meriden, CT (US); David Angelillo, Burlington, CT (US)

(72) Inventors: Christine G. Schilling, Meriden, CT (US); David Angelillo, Burlington, CT (US)

(21) Appl. No.: 15/706,729

(22) Filed: Sep. 17, 2017

(51) Int. Cl. A01L 15/00

(52) U.S. Cl. CPC A01L 15/00

(57) ABSTRACT

The shortcomings of the prior art are overcome and additional advantages are provided through a method for treatment of a crack in the wall of a hoof of an animal having hooves which includes providing at least first and second L-shaped brackets each having a generally planar base side and a substantially planar first flange disposed in substantially perpendicular relationship to said generally planar base followed by securing said first L-shaped bracket to the hoof of a hooved animal on one side of a quarter crack with the substantially planar first flange thereof facing the quarter crack; and securing said second L-shaped bracket to the hoof of the animal on one side of a quarter crack with the substantially planar first flange facing the quarter crack and in opposed relationship with respect to the substantially planar first flange of said first L-shaped clamp; and biasing said first and second flanges together to facilitate healing.

### TECHNICAL FIELD

The present invention has application to equine podiatry which may also be identified as animals having hooves. More particularly, the present invention relates to the hoof wall that surrounds the foot and all inner parts and is divided into three general areas--toe, quarter, and heel. The present invention relates to cracks in the quarter section. While the description herein will make express reference to horses it will be understood the teachings herein have application to other animals having similar structural characteristics.

Hoofed mammals include odd and even toed mammals. Odd-toed ungulates have three extant families: Equidae (horses, asses, and zebras), Rhinocerotidae (rhinoceroses), and Tapiridae (tapirs), with a total of about 17 species The even-toed ungulates are ungulates whose weight is borne equally by the third and fourth toes. By contrast, odd-toed ungulates, such as horses, bear their weight primarily on their third toe. The even toed mammals include the mammalian order Artiodactyl even-toed ungulates, which includes the pigs, peccaries, hippopotamuses, camels, chevrotains, deer, giraffes, pronghorn, antelopes, sheep, goats, and cattle. It is one of the larger mammal orders, containing about 200 species, a total that may be somewhat reduced with continuing revision of their classification. Many artiodactyls are well known to humans, and the order as a whole is of more economic and cultural benefit than any other group of mammals. The much larger order of rodents (Rodentia) affects humans primarily in a negative way, by competing with them or impeding their economic and cultural progress.

Horse owners, farriers, veterinarians and equine practitioners frequently encounter hoof wall cracks. Cracks developing in the quarter section are frequently referred to as quarter cracks. The hoof wall is tough, fibrous, and somewhat elastic in nature. The wall continually grows downward from the coronet. Vertical cracks, which run perpendicular to the ground, are the most common type of hoof crack. The structure of the hoof wall is responsible for the most common type of crack being vertical more often. More particularly, the hoof wall is composed mainly of a protein called keratin, which forms tubules. The tubules are structures that look like densely packed drinking straws. These tubules run vertically down the hoof, from the coronary band to the ground and give the hoof much of its structural strength much like the rebar in concrete. Weaknesses that allow cracks to form are much more likely to develop between the parallel tubules than across the tubules. Thus, quarter cracks usually extend downwardly from the coronary band with the opposed sides of the crack and grow toward the ground. These types of cracks being further apart closer to the ground. The crack may bleed or become infected, causing extreme pain. Radiographs can reveal the presence of foreign objects, coffin bone defects, or coffin bone remodeling that would weaken the wall and create cracks.

Hoof cracks develop for many reasons. A quarter crack is a crack to the outer hoof wall or the hard part of the hoof, a quarter crack can be very minuscule or can be very severe depending on if it is deep enough to expose the soft tissue of the hoof. This crack can be so deep that when a horse walks the opposed sides of the crack will further separate under the horses' weight. This can cause very serious infections which could lead to the horse being crippled or premature death. Most cracks cause the horse pain and inflammation to the soft tissues called the Laminae under the hoof wall, which causes the horse to be lame and unable to perform normal tasks. Some are superficial, some can be permanent. Quarter cracks are usually caused by uneven foot landing. They can also result from many other factors such when the hooves can grow too long if not trimmed regularly, causing cracks and splits), imbalance (when one side of the coronary band is higher than the other), coffin bone defects (e.g. inflammation and demineralization of the coffin bone, fractures, keratomas [tumors of the underlying structures of the Hoover wall], or remodeled coffin bones), constant impact on our services and trauma.

Hoof abscesses can also cause cracks. If the horse has an abscess and the infection drains from the coronary band, a small horizontal crack called a cleft might appear at the airline. Usually, the normal growth of the hoof (comparable to the growth of a human finger nail) result in small clefts disappearing as the hoof normally grows with no problems as long as they are kept clean and reasonably dry.

The construction of the horse hoof will be understood better by reference to images available on the world wide web. See, for example, www.pinterest.com/horselogos/horse-hooves/ as well as other sites identified by a”horse hoof anatomy”search. A “farrier” is a specialist in equine hoof care, including the trimming and balancing of horses' hooves and the placing of shoes on their hooves, if necessary. A farrier combines some blacksmith's skills (fabricating, adapting, and adjusting metal shoes) with some veterinarian's skills (knowledge of the anatomy and physiology of the lower limb) to care for horses' feet.

### BACKGROUND OF THE INVENTION

Attempts to facilitate the closure of such cracks and promote healing include using a shoelace like structure in an attempt to draw the respective sides of the crack together. Such an approach has not been satisfactory because the spacing between the respective sides of the crack is not a constant dimension. More specifically if they shoelace type constraint of the structure is initially tight, subsequent healing may make the opposed sides of the crack closer together. In addition, the spacing between the opposed sides of the A shoelace type constraint is very difficult to adjust to compensate for such developments. Similarly, attempts to dimension essentially a hose clamp around the hoof of the animal because the shape and size of the hole for the animal changes as the animal steps. Furthermore, the circumferential extent of the hoof is not a precise geometric circle. Thus, it is not possible to provide an easily adjustable constraint with either a hose clamp or a shoelace type structure.

From the above, it is therefore seen that there exists a need in the art to overcome the deficiencies and limitations described herein and above.

### SUMMARY OF THE INVENTION

It is an object of the present invention to prevent deterioration of a quarter crack as well as to prevent further injury to the horse.

It is an object of the present invention to prevent deterioration of a quarter crack as well as to prevent further injury to the horse

It is another object of the present invention to hold the opposed walls of a quarter crack in a manner that facilitates adjustment as the hoof wall grows

It is yet another object of the present invention to provide an apparatus and method that accommodates variations in hoof construction as well as variations in the installation of the apparatus.

It is a still further object of the present invention to provide apparatus that will avoid down time for a horse having quarter crack.

It is still another object of the present invention to promote the health of horses that in some cases have their health decimated by the enormity of the associated problems

Lastly, but not limited hereto, it is an even further object of the present invention to remediate a quarter crack injury and return an injured horse to normal activity.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

The shortcomings of the prior art are overcome and additional advantages are provided through a method for treatment of a crack in the wall of a hoof of an animal having hooves which includes providing at least first and second L-shaped brackets each having a generally planar base side and a substantially planar first flange disposed in substantially perpendicular relationship to said generally planar base followed by securing said first L-shaped bracket to the hoof of a hooved animal on one side of a quarter crack with the substantially planar first flange thereof facing the quarter crack; and securing said second L-shaped bracket to the hoof of the animal on one side of a quarter crack with the substantially planar first flange facing the quarter crack and in opposed relationship with respect to the substantially planar first flange of said first L-shaped clamp; and biasing said first and second flanges together to facilitate healing.

In some embodiments, the method further includes the step of providing first and second L-shaped brackets includes providing brackets having a first flanges having a hole therein and biasing is accomplished by a threaded elongated member engaging said first and second first flanges together.

In other embodiments of the invention the method further includes having the step of providing first and second L-shaped brackets further includes providing first and second L-shaped brackets that each having a second flange extending from said base in a direction opposite to said plan that is configured for engagement with a recess in the hoof of the animal.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a side elevation view of the hoof of the horse having a quarter crack extending vertically with the apparatus of the present invention holding the opposed sides of the quarter crack closer together,

FIG. 2 is an isometric view of a bracket shown in FIG. 1 in which hidden lines are shown as dashed lines,

FIG. 3 is a side view of the bracket shown in FIG. 1,

FIG. 4 is an end view of the bracket shown in FIG. 1,

FIG. 5 is a bottom view of the bracket shown in FIG. 1,

### DETAILED DESCRIPTION

Hoof clamp 14 was designed with the thought of preventing such down time and saving the performance of these horses as well as horses that are just companions. The hoof clamp 14 was also designed to prevent severe cracks in the way that it can hold the hoof wall together and prevent it from cracking any further.

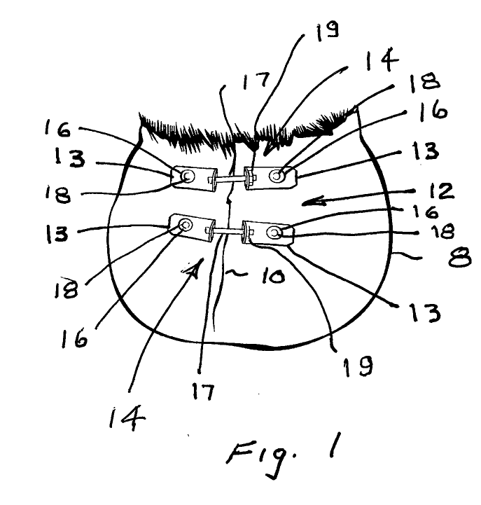

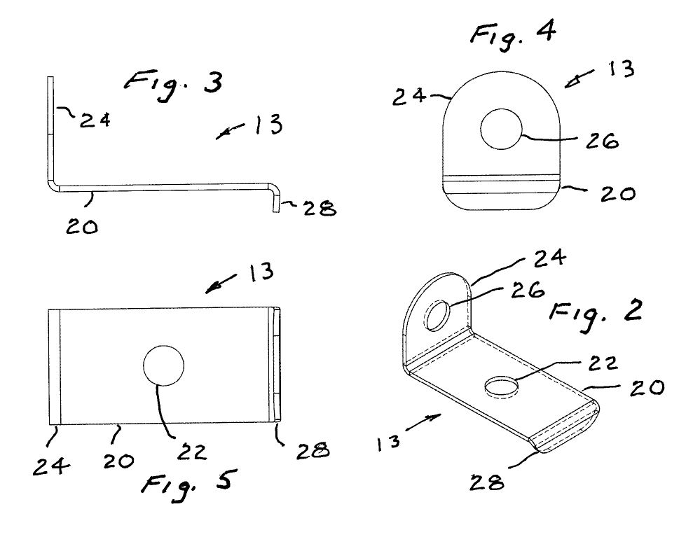

Referring now to FIG. 1 there is shown a horse hoof having a quarter crack 10 extending downwardly. The apparatus and method of the present invention are illustrated with first and second clamps 14 bridging the quarter crack 10. Although two such clamps 14 are shown some cracks may require more of less clamps 14. Each clamp 14 comprises first and second generally L-shaped members 13. Each L-shaped member 13, as best seen in FIGS. 2-5 includes an elongated planar base 20 base. Disposed at the left axial extremity of the base 20, as viewed in FIG. 3, is a large flange 24. The large claims 24 is in most embodiments of the present invention disposed in perpendicular relationship to the base 20 and includes a hole 26 for accommodating an elongated threaded machine screw 17 which cooperates with a threaded nut 19.

Disposed at the right axial extremity of the base 20, as best viewed in FIGS. 3 and 5. is a smaller flange 28. During installation of a generally L-shaped members 13 the installer grinds a recess in the quarter section whereby the smaller flange 28 engages the recess. Typically, the recess is formed with a tool such as the well-known Dremel tool described at Dremel.com.

The recess is not visible in FIG. 1, however, those skilled in the art will be understand that the engagement of the small flange 28 in the recess substantially improves the engagement of each of the generally L-shaped members 13 with the hoof quarter section.

Because of the wall of the hoof has very little thickness, the connection between the wall of the hoof and the base 20 must be very carefully established. More particularly, in a preferred embodiment a ⅛-inch-long coarse thread screw 18 cooperates with a washer 18 to enable an additional connection between the base 20 and the hoof. The connection between the base 20 and the hoof is thus established by a combination of the small flange 28 and a cooperating slot and the screw 18. As best seen in FIG. 1 the opposed walls of the quarter crack 10 are urged together, in a preferred embodiment in each clamp 14 by an 8/32″, 1 inch long screw 17 that cooperates with a locking nut 19. In some embodiments, the machine screw has an Allen key head to facilitate the relative positions of the two generally L-shaped members 13.

Accordingly, one or more clamps 14 ensure that the apparatus of the present invention is capable of maintaining a firm compressive force between the opposed walls of the quarter crack 10 not only at the time of initial installation, but also incident to the entire period that the quarter crack exists. This is vitally important because the conditions throughout the life of the quarter crack are dynamic. More specifically, they continually change. The present invention accommodates these changes by enabling the installer to tighten or loosen the nut 19 that engages the machine screw 17. Furthermore, the clamp 14 accommodates some misalignment of the respective L-shaped pieces 13 in each clamp 14. In a theoretical world, the two L-shaped members in each clamp 14 will be perfectly aligned at all times. In the real world, the alignment may not be perfect at all times. The holes 26 in the large flange 24 allow the application of the required force despite some misalignment between the respective L-shaped members 13. Accordingly, the apparatus in accordance with the present invention prevents further injury as well as facilitates

The hoof clamp 14 is preferably made of 300 series stainless steel. 00 Series stainless steels are classified as austenitic, and are hardenable only by cold working methods. These grades of stainless have chromium (approx. 18 to 30%) and nickel (approx. 6 to 20%) as their major alloying additions. Type 304 is the most widely used alloy of all stainless steels. 300 Series Stainless steel alloys resist corrosion, maintain their strength at high temperatures and are easy to maintain. Preferably, the stainless steel has a grain direction that is perpendicular to both the large flange 24 and the small flange.

The hoof clamp 14 is designed to help the soft tissue or laminae under the hoof wall to heal and bind together by holding the hoof wall in place once the brackets are applied. Holding the hoof wall in place allows for a more speedy recovery because the soft tissue will no longer be put under stress or any further damage. The amount of time the bracket of the present invention needs to be in place depends the growth of the new hoof as well as the preferences of a professional such as a farrier or veterinarian. Typically, a horse treated with that apparatus is capable of exercise and work with the hoof clamp in place if there is no infection or inflammation in the soft tissue of the hoof. The hoof clamp 14 can withstand all terrains and workloads that a horse endures while using this treatment. From time to time the screw 18 may need to be tightened due to healing, however the screw 18 is designed not to back out once tightened however it may loosen, so checking it for proper security is recommended.WHAT SPECIAL ABOUT SCREW?______ The hoof clamp 14 can be applied to the hoof to prevent further cracking of the hoof; the same recommendations apply when it is used preventatively. The hoof clamp 14 can be applied to all hoof sizes making it a vital treatment for Quarter Cracks.

The installation of the hoof clamp 14 preferably includes measuring where the brackets 13 will be applied on either side of a crack. Use a Dremel tool or file to form the recess that engages the small flange 28. Thereafter, each of the brackets 13 are attached to the hoof and secured thereto by screws 18 an small flange 28. It is important to utilize washers under the screw , be sure to use the washers provided so that you 18 heads to insure the screws 18 do not extend too deeply into the hoof wall.

Thereafter, the machine screw 17 is tightened. Embodiments utilizing an alien head will require an Allen wrench. Particular care should be taken to avoid tightening near to any existing inflammation. Periodically, additional tightening of the screw 17, as it becomes loose following any swelling decrease will be appropriate.

If applied correctly by a veterinarian or ferrier the clamps 14 will pull the hoof wall together and the healing process will begin. Follow all instructions by a veterinarian or farrier to take care of any infection or inflammation to the soft tissue of the hoof. This treatment will aide in a speedy recovery pending the above instructions are followed.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for treatment of a crack in the wall of a hoof of an animal having hooves which comprises:
providing at least first and second L-shaped brackets each having a generally planar base side and a substantially planar first flange disposed in substantially perpendicular relationship to said generally planar base;
securing said first L-shaped bracket to the hoof of a hooved animal on one side of a quarter crack with the substantially planar first flange thereof facing the quarter crack;
securing said second L-shaped bracket to the hoof of the animal on one side of a quarter crack with the substantially planar first flange facing the quarter crack and in opposed relationship with respect to the substantially planar first flange of said first L-shaped clamp;
biasing said first and second flanges together to facilitate healing.

2. The method as described in claim 1 wherein the step of providing first and second L-shaped brackets includes providing brackets having a first flanges having a hole therein and biasing is accomplished by a threaded elongated member engaging said first and second first flanges together.

3. The method as described in claim 1 wherein the step of providing first and second L-shaped brackets includes providing first and second L-shaped brackets each having a second flange extending from said base in a direction opposite to said plan that is configured for engagement with a recess in the hoof of the animal.
